(19) United States
(12) Patent Application Publication
(10) Pub. No.: US 2017/0338062 A1
(43) Pub. Date: Nov. 23, 2017

(54) SLIM KEY STRUCTURE

(71) Applicant: PRIMAX ELECTRONICS LTD., Taipei (TW)

(72) Inventor: Yu-Ming Lin, Taipei (TW)

(21) Appl. No.: 15/202,005

(22) Filed: Jul. 5, 2016

(30) Foreign Application Priority Data
May 23, 2016 (TW) 105115971

(51) Int. Cl. H01H 3/12; H01H 13/84

(52) U.S. Cl. CPC H01H 3/125; H01H 13/84

(57) ABSTRACT

The present application provides a slim key structure, including a flexible carrying sheet body, a key cap, a circuit board, a base plate, and a positioning frame cover. The key cap is superimposed over the flexible carrying sheet body, the circuit board is disposed below the flexible carrying sheet body, and the positioning frame cover and the base plate sandwich the key cap, the flexible carrying sheet body, and the circuit board together from the top and the bottom. The key cap includes at least one first hook that protrudes downward, the base plate includes at least one second hook that protrudes upward, and the at least one second hook penetrates through the circuit board to be engaged with the at least one first hook of the key cap. The key cap is evenly carried on the flexible carrying sheet body, and a phenomenon that the key cap wobbles and is unstable would not occur.

### FIELD OF THE INVENTION

The present application relates to a slim key structure, and particularly to a slim key structure that is unlikely to be wobbled for being stably placed.

### BACKGROUND OF THE INVENTION

A keyboard is an indispensable device to modern people for using a computer. A lot of keys are placed on a keyboard for a use to press to input an instruction.

However, because a conventional keyboard must be configured with a scissors foot and/or a rubber dome, the conventional keyboard has relatively great thickness, which is difficult to be improved. Further, because each key is not evenly supported, a phenomenon that a key wobbles and is unstable in either front and rear directions or left and right directions may occur on each key, thereby affecting touch sense of a user in terms of operation. In addition, it is easy for dust or a water drop outside to fall through an edge of a wobbling key into a circuit board of the key, resulting in poor contact of the circuit board. Therefore, a known key still needs to be improved.

### SUMMARY OF THE INVENTION

A main objective of the present invention is to provide a slim key structure where a key cap is disposed on a flexible carrying sheet body, and a bottom face of the key cap is circumferentially stably carried by the flexible carrying sheet body, by means of which the key cap can present a stable state and is unlikely to wobble.

In a preferred implementation concept, a keyboard having a key accommodating function is provided and includes:

a flexible carrying sheet body, defining a hollow region;

a key cap, superimposed over the flexible carrying sheet body and covering the hollow region, where the key cap includes a press-down protruding post and at least one first hook, and the press-down protruding post extends downward from a bottom face of the key cap;

a circuit board, disposed below the key cap and the flexible carrying sheet body, where a switch dome is formed on an upper surface of the circuit board, and a position of the switch dome is aligned with the press-down protruding post of the key cap, so that when the key cap is pressed down, the press-down protruding post presses against the switch dome;

a base plate, disposed below the circuit board, where the base plate includes at least one second hook that protrudes upward, and the at least one second hook penetrates through the circuit board and is engaged with the at least one first hook of the key cap; and

a positioning frame cover, disposed over the flexible carrying sheet body, where the positioning frame cover includes a surrounding wall and a limiting through-hole surrounded and defined by the surrounding wall, the key cap is located at the limiting through-hole and exposed outside, and the surrounding wall has a plurality of positioning prick posts, where the positioning prick posts penetrate into the flexible carrying sheet body and the circuit board to be connected to the base plate.

In a preferred embodiment, the flexible carrying sheet body has an inner peripheral portion, the inner peripheral portion defining the hollow region, where a lower surrounding peripheral portion of the key cap is carried on the inner peripheral portion of the flexible carrying sheet body, and the press-down protruding post of the key cap penetrates through the hollow region of the flexible carrying sheet body.

In a preferred embodiment, the key cap has a central region and an edge region, and the edge region surrounds the central region, where the press-down protruding post is formed on the central region, the lower surrounding peripheral portion is formed on the edge region, and the at least one first hook is formed by protruding from the lower surrounding peripheral portion.

In a preferred embodiment, the circuit board has at least one through-slot, the flexible carrying sheet body has at least one notch, and the at least one second hook of the base plate penetrates through the at least one through-slot and the at least one notch, so as to be engaged with the at least one first hook of the key cap.

In a preferred embodiment, after the at least one first hook extends downward from the lower surrounding peripheral portion of the key cap and protrudes, the at least one first hook is bent outward to form a first bending portion, after the at least one second hook extends upward from the base plate and protrudes, the at least one second hook is bent inward to form a second bending portion, and the first bending portion is hooked by the second bending portion.

In a preferred embodiment, the base plate further includes at least one protruding member that protrudes upward, and the at least one protruding member and the at least one second hook are disposed at an interval, where the at least one protruding member penetrates through the circuit board to push up against the flexible carrying sheet body.

In a preferred embodiment, the flexible carrying sheet body has a plurality of first positioning through-holes, the circuit board has a plurality of second positioning through-holes, the base plate has a plurality of third positioning through-holes, and each of the positioning prick posts of the positioning frame cover penetrates through one of the first positioning through-holes, one of the second positioning through-holes, and one of the third positioning through-holes correspondingly in sequence.

In a preferred embodiment, the flexible carrying sheet body is a ring-shaped sheet body.

In a preferred embodiment, a material of the flexible carrying sheet body is selected from woven fabric; or, a material of the flexible carrying sheet body is selected from an elastic material.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic three-dimensional diagram of a slim key structure according to the present application;

FIG. 2 is an exploded view of a slim key structure along a direction according to the present application;

FIG. 3 is an exploded view of a slim key structure along another direction according to the present application;

FIG. 4 is a sectional view of a slim key structure according to the present application; and

FIG. 5 is a schematic three-dimensional diagram of a slim key structure where drawing of a positioning frame body and a flexible carrying sheet body is omitted according to the present application.

### DETAILED DESCRIPTION OF THE PREFERRED EMBODIMENT

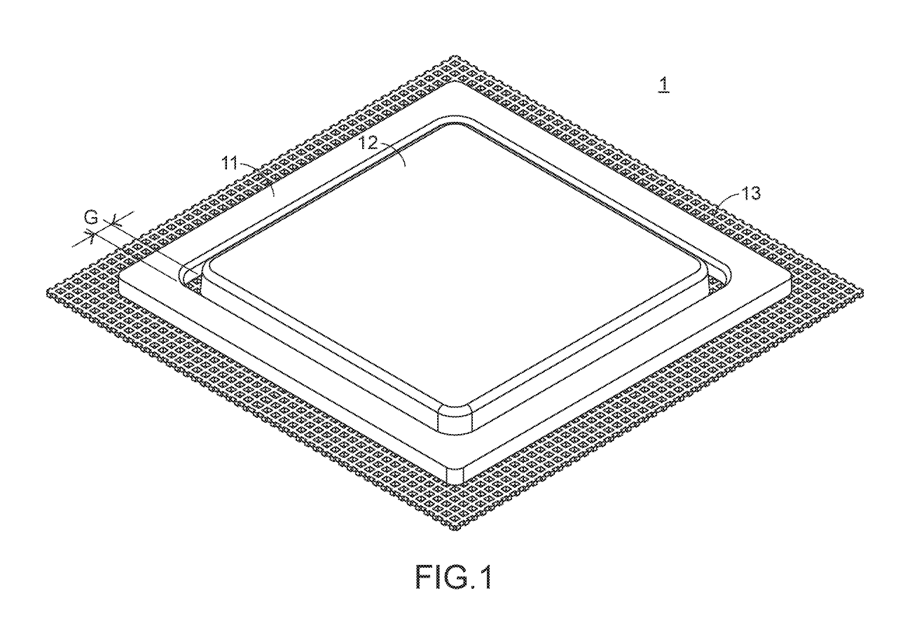

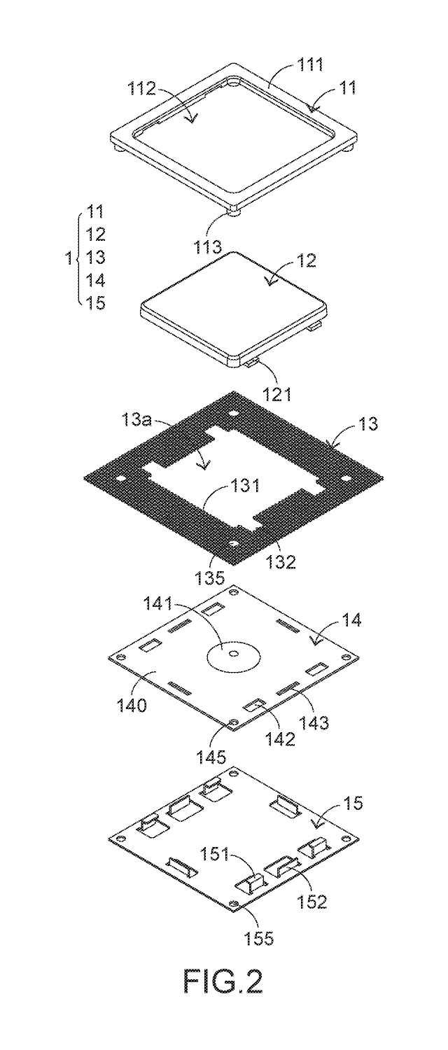

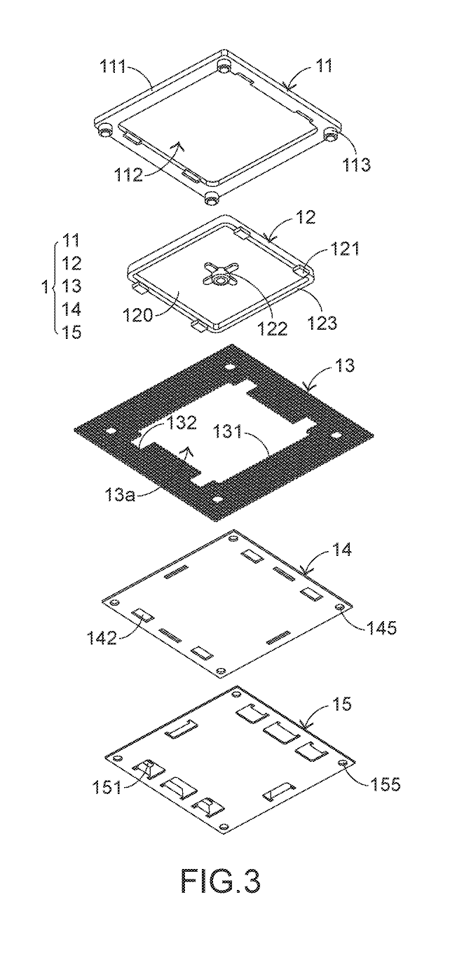

Please refer to FIG. 1 to FIG. 3. FIG. 1 is a schematic three-dimensional diagram of a slim key structure according to the present application, and FIG. 2 and FIG. 3 are exploded views of a slim key structure along different directions according to the present application. First, a relative vertical position relationship between components of the present application is briefly described. A slim key structure 1 of the present application includes a positioning frame cover 11, a key cap 12, a flexible carrying sheet body 13, a circuit board 14, and a base plate 15. The flexible carrying sheet body 13 defines a hollow region 13a, the key cap 12 is superimposed over the flexible carrying sheet body 13, and the key cap 12 covers part or all of the hollow region 13a. The circuit board 14 is disposed below the key cap 12 and the flexible carrying sheet body 13, so as to abut against the circuit board 14 when the key cap 12 moves down. The positioning frame cover 11 is located at the uppermost end of the slim key structure 1, the base plate 15 is located at the lowermost end of the slim key structure 1, and the positioning frame cover 11 and the base plate 15 sandwich the key cap 12, the flexible carrying sheet body 13, and the circuit board 14 together from the top and the bottom.

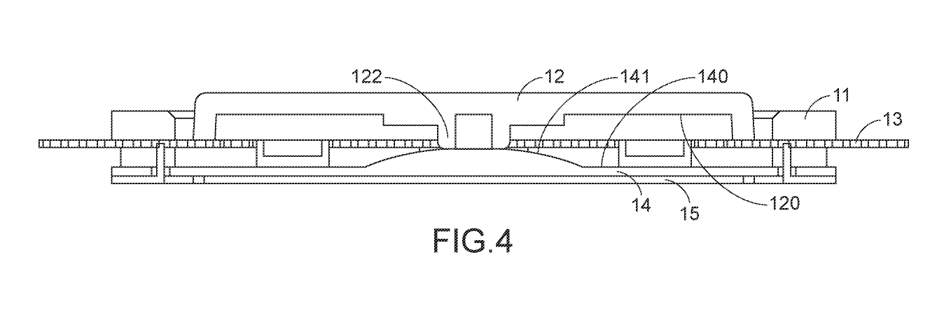

FIG. 4 is a sectional view of a slim key structure according to the present application, and please refer to FIG. 2 to FIG. 4 in combination. In detail, the circuit board 14 has a switch dome 141, and the switch dome 141 is formed on an upper surface 140 of the circuit board 14. The key cap 12 includes a press-down protruding post 122 and a lower surrounding peripheral portion 123, the press-down protruding post 122 extends downward from a bottom face 120 of the key cap 12 and penetrates out of the hollow region 13a of the flexible carrying sheet body 13. The press-down protruding post 122 is formed on a central region of the key cap 12, and a position of the press-down protruding post 122 is aligned with the switch dome 141 of the circuit board 14. It should be noted herein that the switch dome 141 may be a metal dome, usually also referred to as a snap dome. Hence, when the key cap 12 is pressed down by a user, press-down protruding post 122 is adapted to press against the switch dome 141. After the user releases the key cap 12, the switch dome 141 pushes up the press-down protruding post 122 of the key cap 12 back, so as to enable the key cap 12 to return to an initial position. In addition, the lower surrounding peripheral portion 123 of the key cap 12 is formed on an edge region of the key cap 12, and the key cap 12 and its lower surrounding peripheral portion 123 are circumferentially stably carried on the flexible carrying sheet body 13, so that a phenomenon that the key cap 12 loosens and wobbles would not occur.

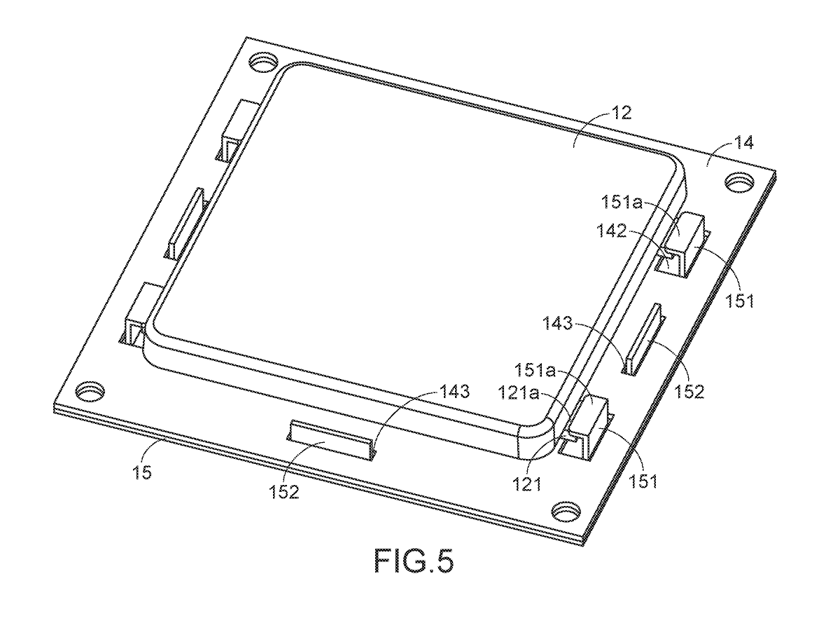

In order to clearly view relationships among some component structures, FIG. 5 is a schematic three-dimensional diagram of a slim key structure where drawing of a positioning frame body and a flexible carrying sheet body is omitted according to the present application. In addition, please refer to FIG. 2, FIG. 3, and FIG. 5 in combination. Further, the key cap 12 further includes at least one first hook 121, which is formed by protruding downward from the lower surrounding peripheral portion 123. The base plate 15 is disposed below the circuit board 14, and the base plate 15 includes at least one second hook 151 that protrudes upward. The at least one second hook 151 of the base plate 15 extends upward and protrudes to penetrate into at least one through-slot 142 of the circuit board 14 and at least one notch 132 of the flexible carrying sheet body 13 in sequence to be engaged with the at least one first hook 121 of the key cap 12. In detail, after the at least one first hook 121 of the key cap 12 extends downward from the lower surrounding peripheral portion 123 of the key cap 12 and protrudes, the at least one first hook 121 is bent outward to form a first bending portion 121a. After the at least one second hook 151 of the base plate 15 extends upward and protrudes, the at least one second hook 151 is bent inward to form a second bending portion 151a, and the first bending portion 121a is hooked by the second bending portion 151a, which serves as a structure for limiting relative displacement between the key cap 12 and the base plate 15.

The positioning frame cover 11 is disposed directly over the flexible carrying sheet body 13, the positioning frame cover 11 includes a surrounding wall 111 and a limiting through-hole 112 surrounded and defined by the surrounding wall 111, and the key cap 12 is located at the limiting through-hole 112 to be partially exposed, so as to be provided for a user to press. The surrounding wall 111 has a plurality of positioning prick posts 113, where the positioning prick posts 113 penetrate into the flexible carrying sheet body 13 and the circuit board 14 to be connected to the base plate 15, so as to be fixed. More specifically, the flexible carrying sheet body 13 has a plurality of first positioning through-holes 135, the circuit board 14 has a plurality of second positioning through-holes 145, the base plate 15 has a plurality of third positioning through-holes 155, each of the positioning prick posts 113 of the positioning frame cover 11 penetrates through one of the first positioning through-holes 135, one of the second positioning through-holes 145, and one of the third positioning through-holes 155 correspondingly in sequence, and the positioning prick post 113 is fixedly connected to the third positioning through-hole 155, so as to enable components of the slim key structure 1 to be tightly superimposed on and fixed to each other.

In addition, the base plate 15 further includes at least one protruding member 152 that protrudes upward, the at least one protruding member 152 extends and protrudes upward to penetrate into the through-slot 143 of the circuit board 14, so as to push up against the flexible carrying sheet body 13, and the at least one protruding member 152 and the at least one second hook 151 are disposed at an interval, so as to evenly supports the flexible carrying sheet body 13 upward.

According to another aspect, a material of the flexible carrying sheet body 13 is preferably selected from elastic woven fabric, a flexible material, or an elastic material. Its shape is preferably a ring-shaped sheet body, that is, structurally, the flexible carrying sheet body 13 has an inner peripheral portion 131, and the inner peripheral portion 131 defines a hollow region 13a. In addition, the key cap 12 is preferably a plastic letter key, and a lower surrounding peripheral portion 123 of the key cap 12 is carried on and connected to the inner peripheral portion 131 of the flexible carrying sheet body 13, that is, presenting a status that the flexible carrying sheet body 13 circumferentially supports the key cap 12.

Moreover, because the flexible carrying sheet body 13 is integrally connected to the key cap 12, a barrier layer is formed on the entire structure, and the barrier layer can prevent impurities outside from falling down into the circuit board 14 and therefore, has waterproof and dustproof effects. Because a gap G exists between the positioning frame cover 15 and the key cap 12, and the flexible carrying sheet body 13 is exposed through the gap G, a manufacturer could change a color of the flexible carrying sheet body 13 to enable the entire product to present a special appearance.

In conclusion, in the slim key structure of the present application, the key cap is circumferentially evenly carried by the flexible carrying sheet body, such that each key is stably placed and a wobbling phenomenon is unlikely to occur on the key, thereby improving touch sense of a user in terms of operation. In addition, the slim key structure of the present application does not need to be configured with a scissors foot and/or a rubber dome, so that thickness of a key is reduced. In addition, the flexible carrying sheet body and the key cap are combined into one piece, so as to prevent impurities from the above from falling into the circuit board 14, thereby enhancing dustproof and drip-proof effects.

The foregoing embodiments merely illustratively describe the principles and effects of the present invention and explain technical features of the present invention instead of limiting the protection scope of the present invention. All the changes or equivalent arrangements that can be easily completed by persons skilled in the art without departing from the technical principles and spirit of the present invention fall within the scope claimed by the present invention. Therefore, the protection scopes of the present invention are listed as the following claims.

What is claimed is:

1. A slim key structure, comprising:
a flexible carrying sheet body, defining a hollow region;
a key cap, superimposed over the flexible carrying sheet body and covering the hollow region, wherein the key cap comprises a press-down protruding post and at least one first hook, and the press-down protruding post extends downward from a bottom face of the key cap;
a circuit board, disposed below the key cap and the flexible carrying sheet body, wherein a switch dome is formed on an upper surface of the circuit board, and a position of the switch dome is aligned with the press-down protruding post of the key cap, so that when the key cap is pressed down, the press-down protruding post presses against the switch dome;
a base plate, disposed below the circuit board, wherein the base plate comprises at least one second hook that protrudes upward, and the at least one second hook penetrates through the circuit board and is engaged with the at least one first hook of the key cap; and
a positioning frame cover, disposed over the flexible carrying sheet body, wherein the positioning frame cover comprises a surrounding wall and a limiting through-hole surrounded and defined by the surrounding wall, the key cap is located at the limiting through-hole and exposed outside, and the surrounding wall has a plurality of positioning prick posts, wherein the positioning prick posts penetrate into the flexible carrying sheet body and the circuit board to be connected to the base plate.

2. The slim key structure according to claim 1, wherein the flexible carrying sheet body has an inner peripheral portion, the inner peripheral portion defining the hollow region, wherein a lower surrounding peripheral portion of the key cap is carried on the inner peripheral portion of the flexible carrying sheet body, and the press-down protruding post of the key cap penetrates through the hollow region of the flexible carrying sheet body.

3. The slim key structure according to claim 2, wherein the key cap has a central region and an edge region, and the edge region surrounds the central region, wherein the press-down protruding post is formed on the central region, the lower surrounding peripheral portion is formed on the edge region, and the at least one first hook is formed by protruding from the lower surrounding peripheral portion.

4. The slim key structure according to claim 3, wherein the circuit board has at least one through-slot, the flexible carrying sheet body has at least one notch, and the at least one second hook of the base plate penetrates through the at least one through-slot and the at least one notch, so as to be engaged with the at least one first hook of the key cap.

5. The slim key structure according to claim 4, wherein after the at least one first hook extends downward from the lower surrounding peripheral portion of the key cap and protrudes, the at least one first hook is bent outward to form a first bending portion, after the at least one second hook extends upward from the base plate and protrudes, the at least one second hook is bent inward to form a second bending portion, and the first bending portion is hooked by the second bending portion.

6. The slim key structure according to claim 1, wherein the base plate further comprises at least one protruding member that protrudes upward, and the at least one protruding member and the at least one second hook are disposed at an interval, wherein the at least one protruding member penetrates through the circuit board to push up against the flexible carrying sheet body.

7. The slim key structure according to claim 1, wherein the flexible carrying sheet body has a plurality of first positioning through-holes, the circuit board has a plurality of second positioning through-holes, the base plate has a plurality of third positioning through-holes, and each of the positioning prick posts of the positioning frame cover penetrates through one of the first positioning through-holes, one of the second positioning through-holes, and one of the third positioning through-holes correspondingly in sequence.

8. The slim key structure according to claim 1, wherein the flexible carrying sheet body is a ring-shaped sheet body.

9. The slim key structure according to claim 1, wherein a material of the flexible carrying sheet body is selected from woven fabric; or, a material of the flexible carrying sheet body is selected from an elastic material.
